(19) United States
(12) Patent Application Publication
(10) Pub. No.: US 2008/0275579 A1
(43) Pub. Date: Nov. 6, 2008

(54) Dynamic derby draw

(75) Inventor: Edward Dennis Scott, Anthem, AZ (US)

Correspondence Address: Edward D. Scott, 3337 W. King Drive, Anthem, AZ, 85086, US

(73) Assignee: Edward D. Scott, Anthem, AZ (US)

(21) Appl. No.: 12/150,097

(22) Filed: Apr. 25, 2008

Related U.S. Application Data
(60) Provisional application No. 60/927,503, filed on May 4, 2007.

(51) Int. Cl. G06F 19/00

(52) U.S. Cl. 700/91

(57) ABSTRACT

A method, system and apparatus is disclosed for scheduling matches in a pool or billiards tournament, or any other competitive event, in a way that allows the next round of competition to begin before the previous round completes when the pairings in the next round depend on the results of the previous round. The present invention ensures that match pairings are done in a fair and random way across all contestants even before the full list of contestants is entirely known. Conventional scheduling methods require all previous round matches to be complete and their full results known before the next round can be scheduled, and consequently, the entire tournament is delayed if even a single match extends beyond a round's desired completion time. The present invention obviates the need for these unknowns to be resolved before scheduling successive rounds, and thereby permits the tournament to proceed on schedule in an orderly, fair and predictable manner.

### CROSS-REFERENCE TO RELATED APPLICATIONS

This application is a non-provisional patent application of, claims priority to and benefit of, U.S. Provisional Patent Application Ser. No. 60/927,503 filed Apr. 30, 2007, the entire contents of which are incorporated herein by reference.

| | |
|---|---|
| Inventor: | Scott; Edward D. |
| Correspondence | Scott; Edward D. |
| Name and | 3337 W. King Drive |
| Address: | Anthem, AZ 85086 |
| | US |
| Appl. No.: | tbd |
| Filed: | tbd |

| | |
|---|---|
| Current U.S. Class: | 700/91; 705/8; 711/137; 715/963; |
| | 463/13,28,42; 273/461; 273/DIG.26 |
| Current International Class: | A63F 13/00 20060101 A63F013/00 A63F |
| | 013/00, G06F 17/00 20060101 G06F017/00; |
| | G06F 19/00 20060101 G06F019/00 |
| Field of Search: | 725/135; 711/137, 717/104; 473/16; |

### COPYRIGHT NOTICE

A portion of the disclosure of this patent document contains or may contain material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

Myriad scheduling algorithms already exist wherein contestants can be matched together in competition with the results of matches in one round determining matches in future rounds. Several popular tournament scheduling algorithms are “round-robin”, “double elimination”, “single elimination”, and “progressive elimination”, the latter being a phrase coined in this context to represent an elimination tournament where a new random draw between rounds determines match-ups for the next round. The distinguishing characteristic of this progressive elimination format is that a new draw—where every contestant has equal likelihood of drawing any other contestant—is done between rounds. An example of this method is the format used for determining rounds and matches played in the annual Derby City Classic billiards tournament in Louisville, Ky.

In the Derby City tournament, for example, hundreds of contestants compete in three events (“Bank Pool”, “One Pocket” and “Nine Ball”). The three events overlap one another and matches from multiple events may occur concurrently. In each tournament event players pay an entry fee and then are matched up by random draw with opponents. The tournament is essentially a single elimination tournament, with one “buyback” exception as discussed below, and losers in each round are eliminated while winners advance to the next round until one final winner emerges. A unique twist on the single elimination format employed at the Derby City tournament is the “buyback” option where losers in a given round may pay a second entry fee and gain entry to the next round provided they have not already used their buyback option (one buyback per player per event).

A key problem with this format, in the absence of the present invention, is that since all the final participants for the next round must be determined before a new random draw can be done, there are arbitrarily long waiting times between rounds until all the late results (whether they are late winners or late buybacks) are in. The entire tournament may be delayed indefinitely awaiting these late results and participants have no idea when they might be required to play again. As a result they tend to congregate around the tournament directors area in a vigil awaiting the next draw for fear they might forfeit their next match if they wander off or try to rest between rounds (see FIG. 1).

These arbitrarily long delays are exacerbated by the fact that in the beginning rounds of an event there are usually many more matches than tables (viz. or courts in tennis, or holes in golf, or lanes in bowling, or tables in bridge, etc.) and it is necessary to schedule matches by table in successive sessions until all matches in the round are complete. Since the length of any given match may vary, it is possible that unpredictable delays can accumulate such that some tables are idle and others are “backed up” with waiting matches. While some shuffling of table assignments can reduce the backlog, in practice it is difficult to manage such changes in real time, and the completion time for the entire round remains unpredictable. Moreover, any dynamic reshuffling of matches, table assignments, playing times, or tournament deadlines (e.g. buyback deadline) to smooth out imbalances can result in players being unaware of these changes and further increases the possibility of forfeiting their matches when previously announced schedules can be changed “on the fly”.

The final list of participants for the next round is not known with certainty until all matches in the prior round are complete and all pending buybacks are resolved. Note that a losing player may elect not to use their buyback option, which further adds to the uncertainty of participants and starting time for the next round.

The present invention addresses these uncertainties in a manner that allows firm scheduling times for each round to be specified (see FIG. 7) and firm playing times to be posted for each match within each round (see FIGS. 10-14). The random draw for the next round can be done at any time during the current round, and the next round can even be started on time on available tables as the current round is winding down. We call the present invention “the dynamic derby draw” in honor of annual the Derby City Classic tournament that inspired it.

### REFERENCES CITED

U.S. PATENT DOCUMENTS

| | | |
|---|---|---|
| 20070088592 | 19-Apr-07 | Liu; Chien-Tsun; et al. |
| 20060252520 | 9-Nov-06 | Platis; Harry B. |
| 20060236036 | 19-Oct-06 | Gschwind; Michael Karl; et al. |
| 20060189389 | 24-Aug-06 | Hunter; Dennis; et al. |
| 20050215300 | 29-Sep-05 | Oliveras; R. Martin |
| 6,425,828 | Jul. 30, 2002 | Walker; et al. |
| 5,359,510 | 25-Oct-94 | Sabaliauskas |

ADDITIONAL DOCUMENTS AND PUBLICATIONS
RELATED TO THE PRESENT INVENTION
(all references cited below are available at
www.pooltournamentmanager.com)

| | | |
|---|---|---|
| The Flash Derby Draw Demo | Scott, E. D. | May, 2007 |
| The Dynamic Derby Draw Scheduler | Scott, E. D. | January, 2008 |
| The Math Behind the Dynamic Derby | Scott, E. D. | Feb. 17, 2008 |
| Draw | | |
| Why I Invented the Dynamic Derby Draw | Scott, E. D. | October, 2007 |
| A Dynamic Derby Draw Simulator | Scott, E. D. | January, 2008 |
| How the Dynamic Derby Draw Works | Scott, E. D. | January, 2008 |

### BRIEF SUMMARY OF THE INVENTION

The present invention relates to a method and apparatus for scheduling the matches in successive rounds of a progressive elimination tournament in a fair and random way even though the preceding round of matches is still in progress and the results of those preceding matches are not yet known. Examples of competitive tournaments where the method can be applied include but are not limited to golf, baseball, soccer, hockey, bowling, billiards, snooker, basketball, football, tennis, boxing, reality TV contests, volleyball, motor racing, arm-wrestling, skiing, sailing, lacrosse, fencing, cross-country, track, darts, bocce, chess, cribbage, bridge, poker, blackjack, cribbage and euchre.

A principal challenge in scheduling these tournaments is keeping the overall tournament on schedule since the duration and outcomes of individual matches are unpredictable. In the prior art one of two strategies are employed for resolving this scheduling problem: 1) schedule all matches in advance with enough cushion or reserve time between matches to minimize overall schedule slippage as matches overrun their allotted times; 2) delay the overall schedule as needed based on accumulated overruns. The first strategy suffers from poor resource utilization because the entire tournament is scheduled toward a worst case match length scenario and no advantage can be taken of early match completions. The second strategy allows for optimal resource utilization but results in complete unpredictability of match playing times and tournament completion.

The present invention employs a new method for keeping the tournament on a predictable schedule even though a given round may be partially complete at such time as the next round must begin.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is screen shot showing an actual picture of tournament players standing around waiting for the next round to start. In the absence of the present invention nobody knows when the next round may start because prior round matches are still in progress.

FIG. 2 shows a partial list of several hundred players who are waiting for the next round draw. In the absence of the present invention the entire field of players is waiting for just a few late matches to complete. The length of the wait is unpredictable.

FIG. 3 explains the primary reason (matches in progress) why, in the absence of the present invention, no one knows when the next round will get underway. It shows a list of several late matches in progress for which the next round is waiting. In the absence of the present invention it is not possible to do a fair and random draw for the next round because the final list of participants is not yet known.

FIG. 4 explains a second reason (late buybacks) why the final list of participants in the next round is unclear.

FIG. 5 announces the present invention as the solution to this protracted and interminable waiting around between rounds.

FIG. 6 shows some of the key scheduling parameters that must be taken into consideration when scheduling tables, matches, rounds, and tournaments. The present invention accommodates all these scheduling parameters in the context of and integrated with the new predictive draw algorithms.

FIG. 7 shows the results of the Dynamic Derby Draw scheduling algorithms as a progressive sequence of firmly scheduled rounds. It employs a proprietary logarithmic algorithm for estimating player reduction through the successive rounds as a result of eliminations from players losing and/or opting not to exercise their buyback option. The ability to produce a firm, reliable overall schedule for each round depends on the present invention's unique ability to start the next round on time even as prior round matches are still in progress and late buybacks may occur.

FIG. 8 shows the time has arrived to perform the dynamic draw even though prior round matches are still in progress.

FIG. 9 shows a description of what is going to happen once the tournament director pressed the Draw button. That's a picture of the happy inventor smiling at you.

FIG. 10 shows the results of the predictive draw and how the majority of matches are scheduled with firm playing times and locations.

FIG. 11 shows the very small minority of players whose matches are not yet scheduled because they are waiting for the results of prior round matches. The vast majority of matches are scheduled and the first session of the next round is already underway on schedule. FIG. 11 also shows a partial list of the full possible pairings for the next round. FIG. 11 also shows there are now only 4 prior round matches still in progress and there are 5 late buybacks that may or may not be in the next round.

FIG. 12 shows how late arrivals from the previous round are entered into the next round taking their pre-assigned positions in the draw. FIG. 12 differs from FIG. 11 in that there are at least 8 matches prior round matches shown as still in progress, and FIG. 12 also shows for the first time the Close Round button which is done after all the prior round matches have completed and the late buybacks are decided (either by buying back in or by failing to meet the buyback deadline and being eliminated).

FIG. 13 shows the results of closing a round after all pending matches and late entrants are decided. In this example, after all the prior round matches were completed and reported, the tournament director closed the round. Note that 4 players failed to pay their buyback fee before the cutoff. All players have now been paired fairly and randomly with their next round opponents, and the bye, if there is one, has been assigned to the first assignee that made it into the next round. The present invention accomplishes this ability to re-pair (Sic.) opponents should their predicted opponents fail to appear in a fair and random way, where the mathematical probability

### DETAILED DESCRIPTION OF THE INVENTION

In the following description, for purposes of explanation, numerous specific details are set forth in order to provide a thorough understanding of the present invention. It will be apparent, however, that the present invention may be practiced without these specific details.

The preferred embodiment of the present invention is a computer program (also called “the system”) comprised of a set of software objects that allow a tournament director or other user to load a player database, define tournament scheduling parameters, and then schedule and manage the rounds. Many embodiments can be envisioned for implementing the present invention. For example, the method for pairing opponents could be done by hand; or a special purpose hardware apparatus could be constructed to automate the method; or a web-based online service could be provided; or implementation could be effected using a plurality of software tools such as Microsoft Excel, or MySQL, etc. The preferred embodiment is a web-based software application using the Macromedia® ActionScript programming language and Flash MX authoring tools. This implementation makes the method available to anyone with a computer and web-based browser and presents the invention with an easy to use graphical interactive interface.

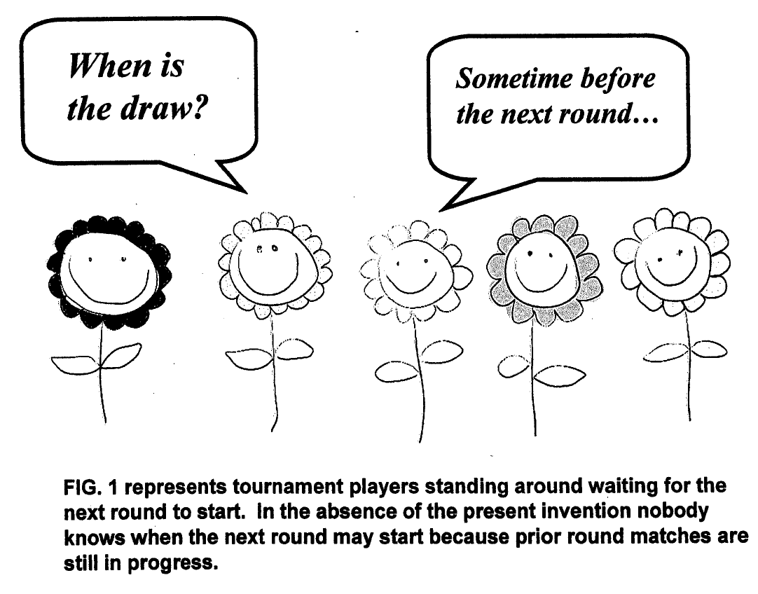

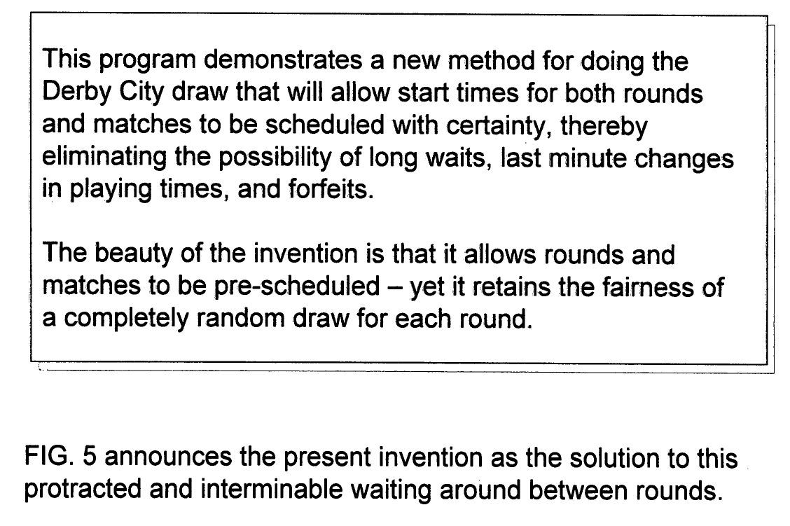

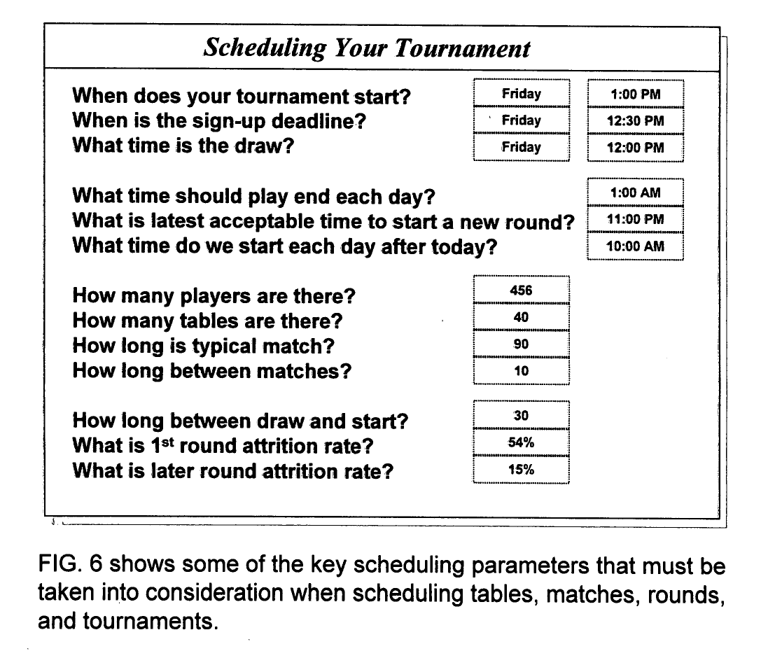

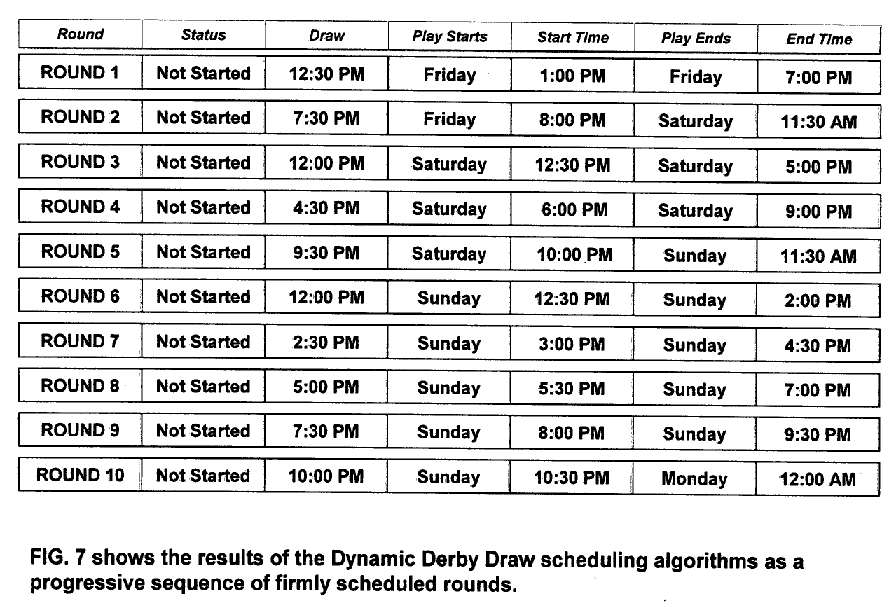

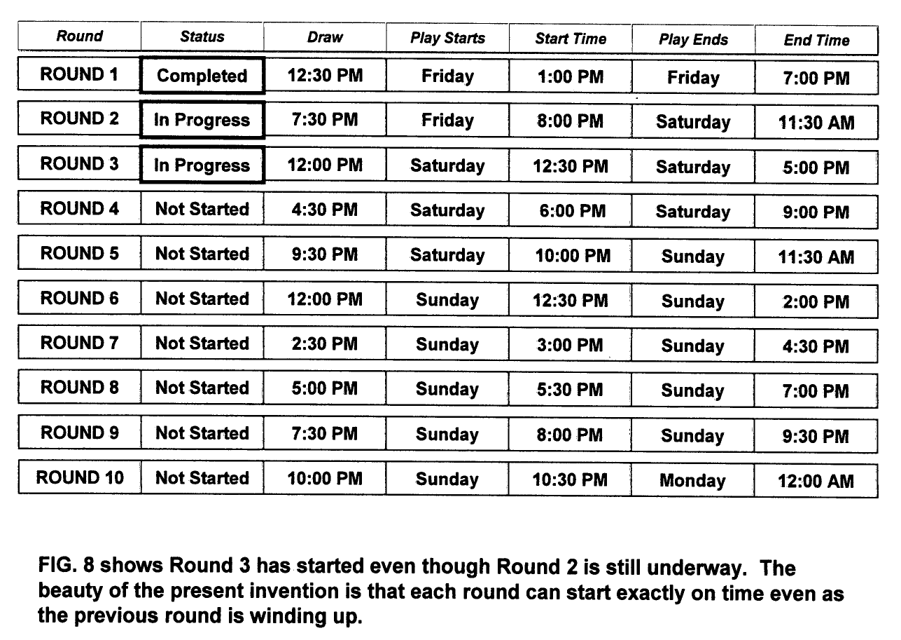

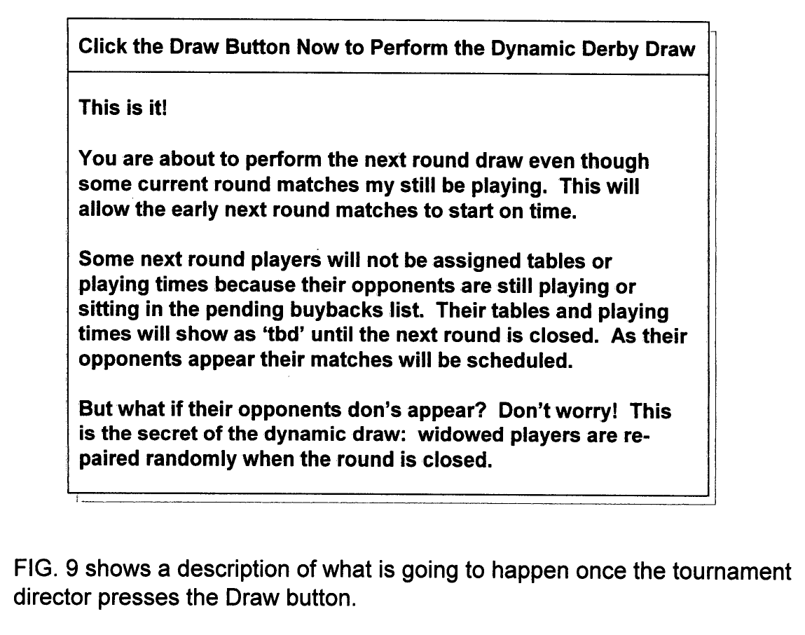

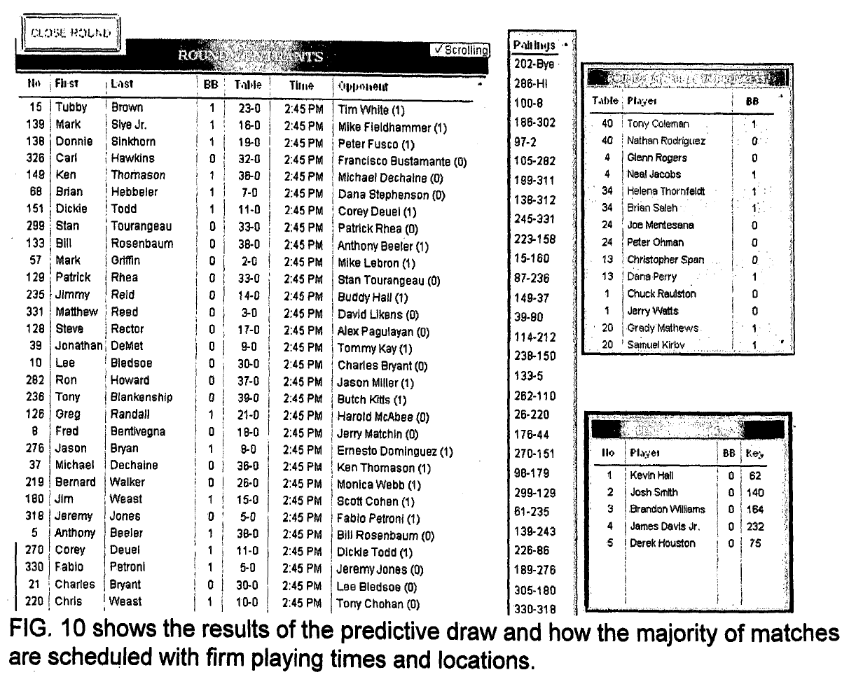

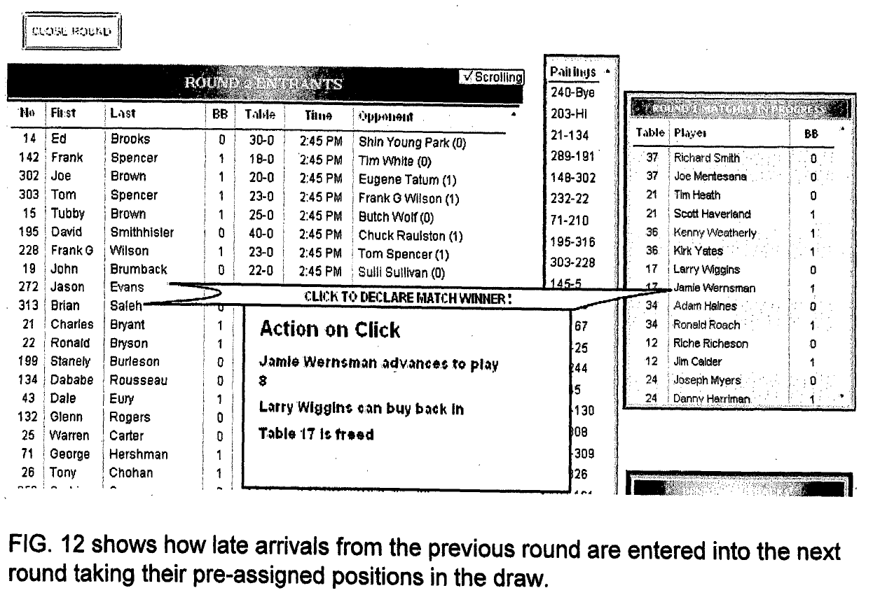

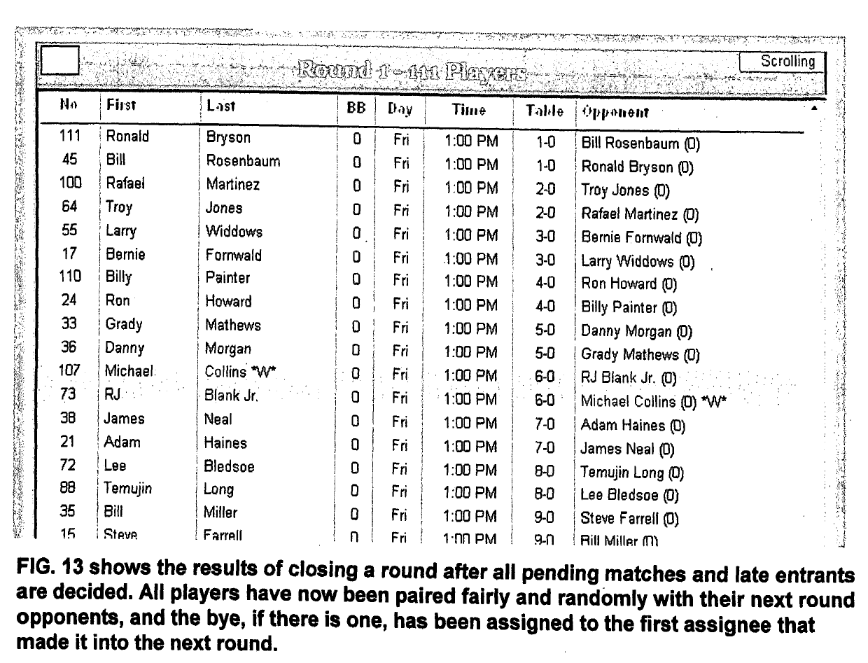

The preferred embodiment of the invention includes the following set of software objects:
Main Movie: presents the invention as a sequence of frames (screen shots—see FIGS. 1-13 inclusive) in which the user sees various animated objects and is offered various choices of inputs and actions including: setting tournament scheduling parameters and resources (FIG. 6); declaring match winners (FIG. 12); activating the predictive draw (FIGS. 8-9); and closing the round (FIGS. 10 and 13).
Movie Objects: presenting the invention and its components as an animated collection of objects responding to user inputs and actions (FIGS. 1-13 inclusive).
ActionScript: implementing the invention as a set of data objects, movie objects and functions required to perform the functions of animation, computation, scheduling, and response to user actions including: the Player Datagrid, the Matches in Progress Datagrid, the Pending Buybacks Datagrid, and the Draw Pairings Datagrid, and the functions required to format, draw, load, sort, scroll and manipulate them; the function for executing the predictive draw; the function for closing the round; the functions for random shuffling; and the functions for pairing and scheduling matches; and others.

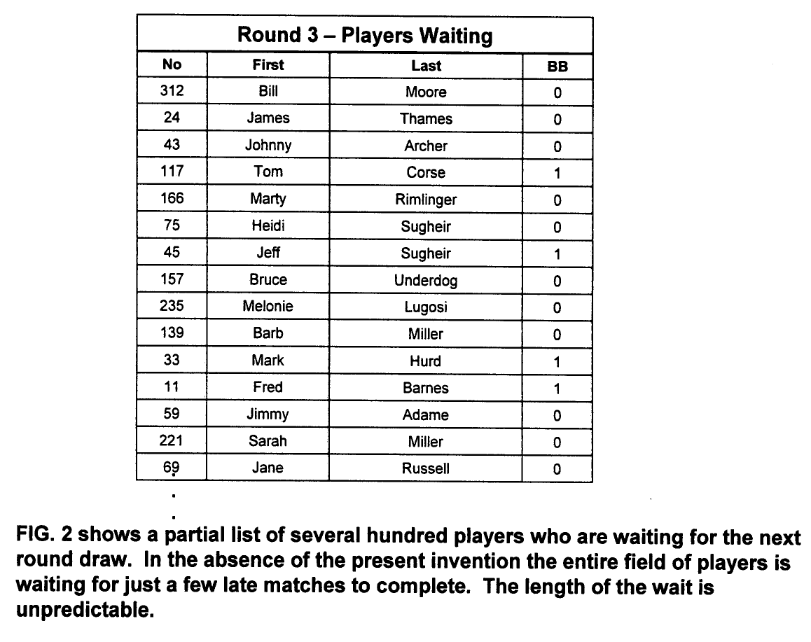

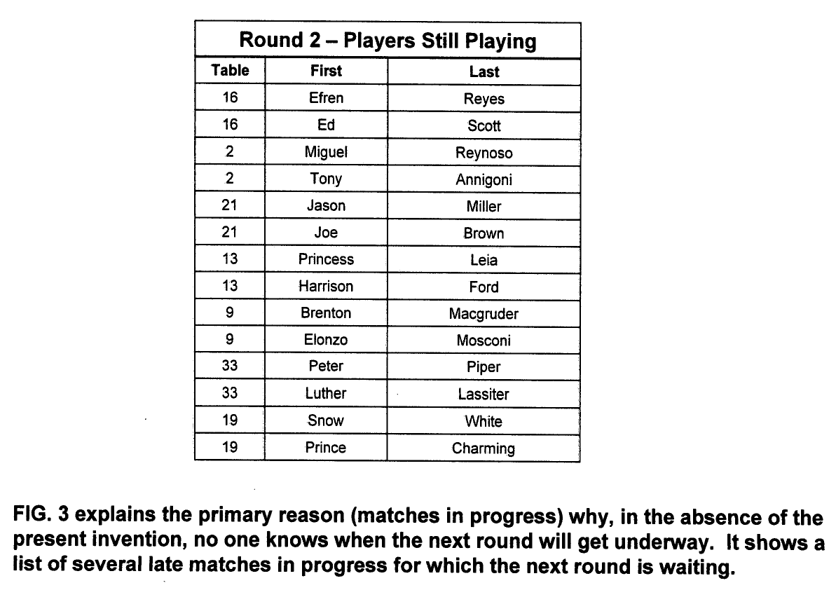

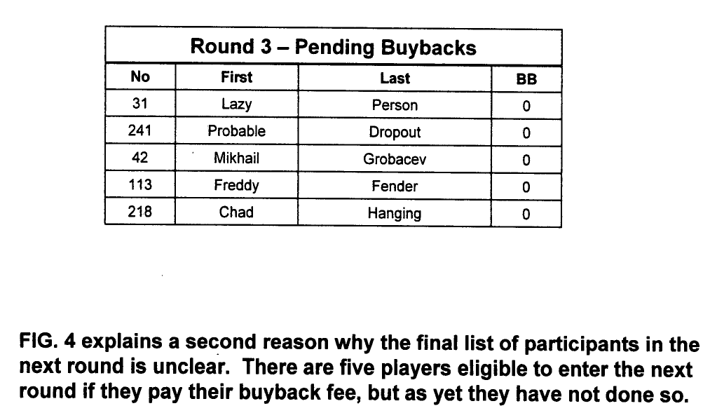

In the preferred embodiment, the user, typically the tournament director or agent is first presented with a series of questions regarding the number of players, number of playing locations, tournament start times, and other scheduling constraints (FIG. 6). A list of players is loaded from an external database representing the participating players and further subdivided according to user specification into a list of available players who will be contestants in the next round (FIG. 2), a list of delayed players currently involved in matches in progress who may or may not become contestants in the next round (FIG. 3), and a list of other players known as the pending buybacks who may or may not appear later as contestants in the next round (FIG. 4). The challenge in scheduling the next round is that these delayed participants make it unclear whom all the final next round participants will be, and therefore, exactly what the pairing of contestants should be. The present invention addresses this challenge by performing the next round draw—the method for determining match pairings fairly across all participants—in two steps.

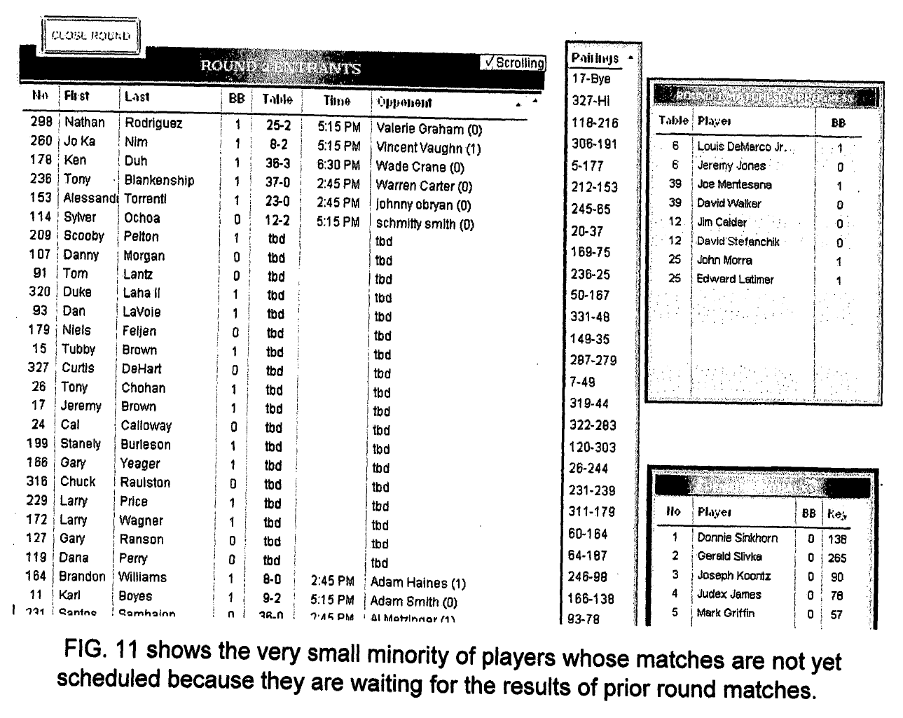

In the first step of the draw, a full field draw is done using a complete list of all known participants plus all potential participants. This step is called the “predictive draw” because it is done without knowing the actual final list of participants. The user activates the predictive draw by pressing the Draw button shown in FIG. 8. Note that the decision to activate the draw can be taken at any time and is driven by a desire to keep the overall tournament on schedule rather than driven by the completion of all previous round matches as is done in the prior art. In the preferred embodiment this draw is done by random selection and the result is the list of match pairings shown in FIG. 10. The predictive draw results in two kinds of matches: those that can be scheduled because both opponents are available; and those that cannot be scheduled because one or more of the opponents are unavailable. The former are assigned times and playing locations and play can begin; the latter show their opponents and schedule details as “tbd” (see FIGS. 10-11).

It is important to emphasize that the next round can begin immediately after the predictive draw since many if not most of the matches are assigned and scheduled. Meanwhile, matches from the previous round continue to complete and the winners are moved into their assigned positions in the pairings, and if their opponent is present their match is scheduled and assigned a playing location (FIG. 12). The losers are either eliminated or moved to the pending buybacks list (FIG. 10). From time to time players on the pending buybacks list pay their buyback fee and are then moved from the pending buybacks list to the final participants list, whereupon these players also are moved into their assigned positions in the pairings, and if their opponent is present their match is scheduled and assigned a playing location too.

In addition to being paired with an opponent randomly like all other players, one lucky player drawn at random is also designated the “bye winner.” This designation becomes important in step two when the draw is closed if there is an odd number of final contestants. Also, the bye winner's opponent receives a special designation as “backup bye winner” in the event the bye winner is eliminated. A plurality of additional strategies may be employed for assigning or reassigning the bye should one or more predecessor assignees become eliminated. An important consideration, as embodied in the present invention, is that this assignment be done fairly such that all participants have an equal chance of getting the bye.

In the second step of the draw, the tournament director declares the list of participants closed. This can only be done after all previous round matches are completed and the winners have moved into the next round (see FIG. 13). Still there may be a few unresolved vacancies in those cases where an expected opponent was eliminated or failed to exercise their buyback option before the deadline. Before these unresolved vacancies are resolved the present invention determines if there is a bye (which only occurs when there is an odd number of final contestants) and if so assigns it in order to a) the original bye winner if available, b) then to the bye winner backup if available and c) one of the remaining unresolved vacancies selected at random. Finally, the remaining unresolved vacancies are resolved by randomly pairing them with each other. The result if a full and complete final scheduling of all matches in the round as shown in FIG. 13.

For an animated demonstration of how the present invention works and related articles see www.pooltournamentmanager.com.

### SUMMARY OF THE INVENTION

It is an object of the invention to facilitate the scheduling of large tournaments in a manner such that the many individual participants can be kept informed of and rely upon their scheduled playing times and locations even though dynamic events continuously change scheduling assumptions.

It is an object of the invention to permit the next round of matches in a tournament to be scheduled predictably and durably even though the current round of matches is still in progress.

It is an object of the invention to post firm playing times so players can rest between matches and arrive promptly before their matches begin.

### PUBLIC NOTICE REGARDING THE SCOPE OF THE INVENTION AND CLAIMS

It will be readily seen by one of ordinary skill in the art that the present invention fulfills all of the objects set forth above. After reading the foregoing specification, one of ordinary skill will be able to effect various changes, substitutions of equivalents and various other aspects of the invention as broadly disclosed herein. It is therefore intended that the protection granted hereon be limited only by the definition contained in the appended claims and equivalents thereof.

The inventor considers various elements of the aspects and methods recited in the claims filed with the application as advantageous, expressly in any particular claim.

While the invention has been described in terms of preferred embodiments and generally associated methods, the inventor contemplates that alterations and permutations of the preferred embodiments and methods will become apparent to those skilled in the art upon a reading of the specification and a study of the drawings.

Additional structure can be included, or additional processes performed, while still practicing various aspects of the invention claimed without reference to such structure or processes.

Accordingly, neither the above description of preferred exemplary embodiments nor the abstract defines or constrains the invention. Rather, the issued claims variously define the invention. Each variation of the invention is limited only by the recited limitations of its respective claim, and equivalents thereof, without limitation by other terms not present in the claim.

The words “comprising,” “including,” and “having” are intended as open-ended terminology, with the same meaning as if the phrase “at least” were appended after each instance thereof. A clause using the term “whereby” merely states the result of the limitations in any claim in which it may appear and does not set forth an additional limitation therein. Both in the claims and in the description above, the conjunction “or” between alternative elements means “and/or,” and thus does not imply that the elements are mutually exclusive unless context or a specific statement indicates otherwise.

What is claimed is:

1. A method for scheduling successive rounds in a progressive elimination tournament reliably even though successive rounds depend upon the unpredictable results of prior rounds, said method comprising: a plurality of contestants, a plurality of playing locations, a plurality of matches, and a plurality of possible late entrants; a plurality of user-specified scheduling parameters; a means of matching pairs of opponents in successive rounds fairly; a means of starting a subsequent round before its immediately prior round completes; a means of transitioning late entrants into a round in progress without disruption; a means of finalizing all match schedules by resolving vacancies fairly; and a means of assigning bye(s) fairly when needed.

2. The method according to claim 1 wherein said predictive draw for the next round can be done at any time during the current round under user control.

3. The method according to claim 1 wherein matches in the next round can be assigned firm times and playing locations not in conflict with themselves or other matches in progress.

4. The method according to claim 1 wherein vacancies created by a predictive draw are later filled in a fair and impartial manner.

5. The method according to claim 1 wherein a fair selection of a “bye” match needs to be made and possibly remade, if one or more original designees, are eliminated in a manner that is fair to all participants.

6. The method according to claim 1 wherein a master timetable of all rounds is done based on a logarithmic prediction of successive round size reduction.

7. A system for scheduling successive rounds in a progressive elimination tournament reliably even though successive rounds depend upon the unpredictable results of prior rounds, said system comprising: a plurality of contestants, a plurality of playing locations, a plurality of matches, and a plurality of possible late entrants; a plurality of user-specified scheduling parameters; a means of matching pairs of opponents in successive rounds fairly; a means of starting a subsequent round before its immediately prior round completes; a means of transitioning late entrants into a round in progress without disruption; a means of finalizing all match schedules by resolving vacancies fairly; and a means of assigning bye(s) fairly when needed.

8. The system according to claim 7 wherein said predictive draw for the next round can be done at any time during the current round under user control.

9. The system according to claim 7 wherein matches in the next round can be assigned firm times and playing locations not in conflict with themselves or other matches in progress.

10. The system according to claim 7 wherein vacancies created by a predictive draw are later filled in a fair and impartial manner.

11. The system according to claim 7 wherein a fair selection of a “bye” match needs to be made and possibly remade, if one or more original designees, are eliminated in a manner that is fair to all participants.

12. The system according to claim 7 wherein a master timetable of all rounds is done based on a logarithmic prediction of successive round size reduction.

13. A computer-readable medium storing at least one sequence of executable instructions providing a method for scheduling successive rounds in a progressive elimination tournament reliably even though successive rounds depend upon the unpredictable results of prior rounds, said method comprising: a plurality of contestants, a plurality of playing locations, a plurality of matches, and a plurality of possible late entrants; a plurality of user-specified scheduling parameters; a means of matching pairs of opponents in successive rounds fairly; a means of starting a subsequent round before its immediately prior round completes; a means of transitioning late entrants into a round in progress without disruption; a means of finalizing all match schedules by resolving vacancies fairly; and a means of assigning bye(s) fairly when needed.

14. A computer readable medium as recited in claim 13 further comprising: a list or database of players of any arbitrary number; a subset of the above selection of players representing those participants immediately available for scheduling their matches; and a second subset list of players representing the complement who are not immediately available for scheduling their matches.

15. The computer readable medium according to claim 13 wherein a predictive draw for the next round can be done at any time during the current round under user control.

16. The computer readable medium according to claim 13 wherein matches in the next round can be assigned firm times and playing locations not in conflict with themselves or other matches in progress.

17. The computer readable medium according to claim 13 wherein vacancies created by a predictive draw are filled in a fair and impartial manner.

18. The computer readable medium according to claim 13 wherein a fair selection of a “bye” match needs to be made and possibly remade if the original designee is eliminated in a manner that is fair to all participants.

19. The computer readable medium according to claim 13 wherein a master timetable of all rounds is done based on a logarithmic prediction of successive round size reduction.
